(19) United States
(12) Patent Application Publication
(10) Pub. No.: US 2008/0019137 A1
(43) Pub. Date: Jan. 24, 2008

(54) Backlight

(75) Inventors: Masashi Takai, Saitama (JP); Sachiko Ando, Aichi (JP); Yohei Funabashi, Tokyo (JP); Yasumaro Toshima, Saitama (JP); Takashi Shimizu, Saitama (JP); Masayuki Nakatani, Saitama (JP); Reiko Takahashi, Saitama (JP); Hiroshi Matsuyama, Saitama (JP)

Correspondence Address: BACON & THOMAS, PLLC, 625 SLATERS LANE, FOURTH FLOOR, ALEXANDRIA, VA, 22314, US

(73) Assignee: Kimoto Co., Ltd., Tokyo (JP)

(21) Appl. No.: 11/630,338

(22) PCT Filed: Jul. 6, 2005
(86) PCT No.: PCT/JP05/12481

§ 371 Date: Dec. 21, 2006

(30) Foreign Application Priority Data
Jul. 7, 2004 (JP) 2004-200148

(51) Int. Cl. F21V 5/02

(52) U.S. Cl. 362/311

(57) ABSTRACT

Because light diffusing plates constituting backlight units have high moisture absorbency, light diffusing plates cause deformation such as warp, swell and flexure and adversely affect other members such as liquid crystal cells to cause defective images. A backlight unit that does not generate defective images due to such deformation of light diffusing plate is provided. This backlight unit is a backlight unit 1 comprising light sources 13, a light diffusing plate 14 comprising a synthetic resin and disposed on the light sources, and one or more kinds of optical members 15 and 16 for backlight unit disposed on the light diffusing plate, wherein both surfaces of the light diffusing plate 14 shall have an arithmetical mean deviation (Ra) of 0.1 μm or less according to JIS B0601:1994.

### TECHNICAL FIELD

The present invention relates to a backlight unit which does not cause dimensional change over time, and thus does not suffer from degradation of optical characteristics over time.

### BACKGROUND ART

Consumption of backlight units used for liquid crystal displays, illumination signboards, and so forth is markedly increasing with increase of shipment of liquid crystal displays for notebook computers, large-sized liquid crystal televisions and so forth.

As such backlight units, backlight units of the edge light type and direct type are mainly used. Since backlight units of the edge light type themselves can be manufactured with a small thickness, they are used for notebook computers etc., whereas backlight units of the direct type are used for large-sized liquid crystal televisions etc. in many cases.

Among these backlight units, backlight units of the edge light type are constituted by, besides light source and light guide plate, optical members such as prism sheet, light diffusing film, light reflecting film, polarization film, reflection type polarization film, retardation film and electromagnetic wave shielding film, and backlight units of the direct type are constituted by, besides light source and light diffusing plate, optical members such as prism sheet, light diffusing film, light reflecting film, polarization film, reflection type polarization film, retardation film and electromagnetic interference shielding film (refer to Patent document 1).

Liquid crystal displays assembled by using such backlight units as described above hardly suffer from defective images over time except for defective switching of light source.

However, because of high moisture absorbency of light diffusing plates constituting backlight units, light diffusing plates cause deformation such as warp, swell and flexure, and it poses a problem of bad influence on other members such as liquid crystal cells (refer to Patent document 2).

Patent document 1: Japanese Patent Unexamined Publication (KOKAI) No. 9-127314 (claim 1, paragraph 0034)

Patent document 2: Japanese Patent Unexamined Publication (KOKAI) No. 2004-9524 (Related Art, paragraph 0036)

### DISCLOSURE OF THE INVENTION

### Object to be Achieved by the Invention

In order to solve the aforementioned problem, the inventors of the present invention conducted various researches, and as a result, they found that by making a surface profile of light diffusing plate fall within a specific range, warp, swell and flexure could be prevented, and thus solved the problem.

### Means for Achieving the Object

That is, the backlight unit of the present invention is a backlight unit comprising a light source, a light diffusing plate for diffusing lights from the light source, and one or more kinds of optical members for backlight unit disposed on the light diffusing plate, wherein the light diffusing plate comprises a synthetic resin, and both surfaces of the light diffusing plate have an arithmetic average roughness (Ra) of 0.1 μm or less according to JIS B0601:1994.

The backlight unit of the present invention is also a backlight unit comprising a light source, a light diffusing plate comprising a synthetic resin and disposed on the light source, and one or more kinds of optical members for backlight unit disposed on the light diffusing plate, wherein both surfaces of the light diffusing plate have an arithmetical mean deviation (Ra) of 0.1 μm or less according to JIS B0601:1994.

### EFFECT OF THE INVENTION

According to the present invention, a backlight unit that does not cause defective images on liquid crystal displays due to deformation of a light diffusing plate such as warp, swell and flexure can be provided by making a surface profile of the light diffusing plate fall within a specific range.

### BEST MODE FOR CARRYING OUT THE INVENTION

Embodiments of the backlight unit of the present invention will be explained. The backlight unit of the present invention is a backlight unit comprising a light source, a light diffusing plate comprising a synthetic resin, and one or more kinds of optical members for backlight unit disposed on the light diffusing plate, wherein both surfaces of the light diffusing plate have an arithmetical mean deviation (Ra) of 0.1 μm or less according to JIS B0601:1994. The backlight of the present invention is especially suitably used for backlight units of the so-called direct type.

An embodiment of the backlight unit of direct type is shown in FIG. 1. As shown in the drawing, in this backlight unit 1, multiple light sources 13 are disposed on a reflecting film 12 accommodated in a chassis 11, and a light diffusing film 15 and a prism sheet 16 are disposed thereon via a light diffusing plate 14. As the light diffusing plate 14, one having an arithmetical mean deviation (Ra) of 0.01 μm or less according to JIS B0601:1994 for both the surfaces is used.

As the light source 13 of the backlight unit, a cold-cathode tube is mainly used. Examples of the shape of the light source include linear shape, U shape, and so forth.

The light diffusing plate constituting the backlight unit is provided on the light sources, and plays a role of erasing the pattern of the light sources, and it mainly consists of a synthetic resin. Since such a light diffusing plate is used in order to erase the pattern of the light sources, it must have a large thickness as thick as 1 to 10 mm, and it is different from a light diffusing film having a thickness of 12 to 350 μm, which is used in order to improve front luminance and give an appropriate viewing angle.

Examples of the synthetic resin constituting the light diffusing plate include thermoplastic resins, thermosetting resins, ionizing radiation curing resins, and so forth, such as polyester type resins, acrylic type resins, acryl/urethane type resins, polyester acrylate type resins, polyurethane acrylate type resins, epoxy acrylate type resins, (meth)acrylate/styrene copolymer type resins, urethane type resins, epoxy type resins, polycarbonate type resins, cellulose type resins, acetal type resins, polyethylene type resins, polystyrene type resins, polyamide type resins, polyimide type resins, melamine type resins, phenol type resins, cyclic olefin type resins and silicone type resins. Among these, acrylic type resins having superior optical characteristics are preferably used. In view of dimensional stability, (meth)acrylate/styrene copolymer type resins and cyclic olefin type resins are preferably used.

To the light diffusing plate, microparticles are added in order to impart a light diffusing property. Examples of the microparticles include inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylate resin.

Although the amount of the microparticles added is not particularly limited, it is usually 0.1 to 20 weight parts with respect to 100 weight parts of the resin.

Both the surfaces of the light diffusing plate should have an arithmetical mean deviation (Ra) according to JIS B0601:1994 of 0.1 μm or less, preferably 0.01 μm or less, more preferably 0.008 μm or less. As a light diffusing plate used for backlight unit, it is usually desired to use those having convexes and concaves for at least one surface from various reasons or purposes, for example, for preventing Newton rings to be generated between a light diffusing plate and an optical member for backlight unit disposed on the light diffusing plate, for preventing glares of displayed images, for making scratches of a light diffusing plate itself inconspicuous, and so forth, and a light diffusing plate having an arithmetical mean deviation (Ra) of 0.1 μm or less as defined in the present invention, of which profile is almost that of a mirror surface, is not used for backlight units. However, in the backlight unit of the present invention, deformation of the light diffusing plate can be prevented by using a light diffusing plate having a profile almost that of a mirror surface.

Such a light diffusing plate can be prepared by, for example, molding a synthetic resin composition containing microparticles for imparting a light diffusing property, and other components as required into a shape of plate by any of methods including extrusion molding, injection molding, press molding, and so forth. The thickness of the light diffusing plate is about 1 to 10 mm, preferably about 1 to 5 mm. As a light diffusing plate having such an arithmetical mean deviation (Ra) as defined in the present invention, one having a surface made as a mirror surface at the time of molding is used. Alternatively, such a light diffusing plate can be obtained by subjecting a molded resin plate to a mirror surface processing to make the surface into a substantially mirror surface.

The reason why generation of deformation such as warp, swell and flexure can be prevented by the configuration described above will be explained together with the cause of the generation of deformation.

First, most of light diffusing plates comprise synthetic resins in view of optical characteristics, weight, and so forth. Synthetic resins show high water vapor permeation and are likely to absorb moisture. If such a light diffusing plate that is likely to absorb moisture is left under a high humidity environment for a long period of time, the light diffusing plate absorbs a lot of moisture. When a backlight is turned on with a light diffusing plate containing absorbed moisture so much as described above, rapid moisture emission is started by heat of light sources. Because this moisture emission does not uniformly occur over the light diffusing plate, but it is likely to occur at positions of the light diffusing plate near the light sources, there is generated an uneven condition that moisture is emitted around the light sources, whereas moisture emission is insufficient and absorbed moisture remains in other portions. In such a condition, the portions where moisture is emitted (portions near the light sources) shrink unlike the portions where absorbed moisture remains, and thus the light diffusing plate falls into a deformed state. Briefly, it is considered that the deformation is caused by partial unevenness of degree of moisture absorption. In particular, when one surface of light diffusing plate has convexes and concaves, the surface area becomes larger compared with a surface having no convex and concave, thus it becomes more easily cause moisture absorption and emission, and the uneven state becomes more likely to occur. Therefore, it becomes likely to generate deformation such as warp, swell and flexure.

When flexure is generated only in the light diffusing plate, local defective images are hardly seen on the display screen of liquid crystal display. However, if an optical member such as prism sheet, light diffusing film, light reflecting film, polarization film, reflection type polarization film, retardation film and electromagnetic wave shielding film is disposed on the light diffusing plate in which flexure is generated, local defective images become extremely marked. That is, as shown in FIG. 2, the optical member disposed on the light diffusing plate shall follow the shape of the light diffusing plate when the light diffusing plate has no flexure or the flexure is small, but if the flexure becomes large, it cannot follow the flexure, and generates deformation by its own weight. Thus, local defective images become extremely significant due to the deformation of the optical member. This deformation of an optical member has become more significant with use of wider backlight units (having a light emitting surface of 900 cm² or larger as backlight unit) and thus use of wider optical members for the production of larger liquid crystal displays.

According to the present invention, by using a light diffusing plate having an arithmetical mean deviation (Ra) of 0.1 μm or less according to JIS B0601:1994 for both the surfaces as a light diffusing plate constituting a backlight unit, deformation of the light diffusing plate can be prevented, thus deformation of optical members is prevented, and generation of local defective images in a liquid crystal display can be prevented. On the other hand, if a usually used light diffusing plate having an arithmetical mean deviation of about 0.30 μm is used, deformation of the light diffusing plate cannot be prevented, thus optical members cannot follow the deformation of the light diffusing plate, and deformation of optical members is caused, resulting in generation of local defective images.

If deformation is once generated in an optical member, it is difficult to make it completely flat like the original shape. That is, if deformation is once generated in an optical member, defective images will permanently remain. Therefore, the present invention enabling prevention of the generation of deformation is extremely useful.

Because the backlight unit of the present invention explained above uses a light diffusing plate having an arithmetical mean deviation (Ra) of 0.1 μm or less according to JIS B0601:1994 for both the surfaces as a light diffusing plate, it can prevent deformation of the light diffusing plate, thereby prevent deformation of an optical member disposed on the light diffusing plate, and therefore prevent local defective images of display. This effect is extremely useful for wide backlight units having a light projecting surface area of 900 cm² or larger, in which the problem of deformation is likely to occur. Since such wide backlight units are often used in backlight units of the direct type, the present invention can be particularly suitably applied for backlight units of the direct type. However, the present invention can also be applied for backlight units of the edge light type.

On the light diffusing plate of a backlight unit of the direct type, one or more kinds of optical members are disposed depending on the purpose. Examples of such optical members include prism sheet, light diffusing film, light reflecting film, polarization film, reflection type polarization film, retardation film, electromagnetic wave shielding film, and so forth. For example, examples of prism sheet include BEF II (trade name), RBEF (trade name), Wave film (trade name) of Sumitomo 3M Co., Ltd., and DIAART (trade name) of Mitsubishi Rayon Co., Ltd. Examples of light diffusing film include OPALUS (trade name) of Keiwa Inc., and D114 (trade name) of TSUJIDEN Co., Ltd. Examples of light reflecting film include LEIRA (trade name) of Keiwa Inc., and ESR (trade name) of Sumitomo 3M Co., Ltd. Examples of polarization film include NPF (trade name) of NITTO DENKO CORP., and Sumikalan (trade name) of Sumitomo Chemical Co., Ltd. Examples of reflection type polarization film include DBEF of Sumitomo 3M Co., Ltd. Examples of retardation film include ELMECH (trade name) of Kaneka Corporation, and Sumikalight (trade name) of Sumitomo Chemical Co., Ltd. Examples of electromagnetic wave shielding film include ELECRYSTA (trade name) of NITTO DENKO CORP., and REFTEL (trade name) of Teijin Ltd.

In addition, a Newton-ring preventing layer or a anti-blocking layer may be provided on a surface of any of the aforementioned optical members to be brought into contact with the light diffusing plate. Alternatively, a film having such function may be inserted between any of the optical members and the light diffusing plate. Even when a light diffusing plate having a surface profile of almost mirror surface is used, generation of Newton rings or blocking can be thereby prevented.

Moreover, an optical member may be provided at other positions in backlight units of the direct type, for example, on the side of the light source opposite to the light diffusing plate side, and so forth.

### EXAMPLES

Hereafter, the present invention will be further explained with reference to examples. The term “part” and symbol “%” are used on weight basis, unless especially indicated.

### Example 1

Production of Light Diffusing Plate

To 100 weight parts of acrylic resin heated and stirred by a mixer, 2.5 weight parts of silicone beads were added, and the mixture was stirred until the mixture became uniform. Then, the mixture was extruded by an extruder, and cut to produce acrylic resin pellets in the shape of small circular cylinder (size: diameter of about 3 mm×length of about 5 mm). Then, by using these pellets, a light diffusing plate (thickness: 2 mm) having an arithmetical mean deviation (Ra) of 0.01 μm according to JIS B0601:1994 for both the surfaces of the light diffusing plate was produced by injection molding.

Production of Backlight Unit

The aforementioned light diffusing plate was disposed on light sources, and an optical member (light diffusing film) was further disposed on the light diffusing plate to obtain a backlight unit of Example 1 having a light projecting surface area of 2090 cm² (size: 26 inches)

### Example 2

A light diffusing plate (thickness: 2 mm) having an arithmetical mean deviation (Ra) of 0.005 μm was produced by injection molding using the same pellets as those used in Example 1, and a backlight unit of Example 2 was obtained.

### Example 3

A light diffusing plate (thickness: 2 mm) having an arithmetical mean deviation (Ra) of 0.06 μm was produced by injection molding using the same pellets as those used in Example 1, and a backlight unit of Example 3 was obtained.

### Comparative Example 1

A light diffusing plate (thickness: 2 mm) having an arithmetical mean deviation (Ra) of 0.30 μm was produced by injection molding using the same pellets as those used in Example 1, and a backlight unit of Comparative Example 1 was obtained.

[Evaluation of Flexure]

The backlight units obtained in Examples 1 to 3 and the comparative example were left in an environment of 40° C. and 90% RH for 24 hours, and then each incorporated into a marketed 26-inch liquid crystal TV. The liquid crystal TV was turned on, and change of image condition was observed.

As a result, any defective image was not generated on the screen of the liquid crystal TV using the backlight unit of Example 1 or 2 even after many hours passed from the turning on. Further, when optical members (light diffusing films) incorporated into the liquid crystal TV were taken out and observed, flexure was not observed for both the members. With the backlight unit of Example 3, although defective images were not generated on the screen of liquid crystal TV within 24 hours after the turning on, a few defective images were observed after 24 hours passed. When an optical member (light diffusing film) incorporated into the liquid crystal TV was taken out within 24 hours and after 24 hours passed, and observed, flexure was not observed within 24 hours, but a little flexure was observed after 24 hours passed.

On the other hand, with the backlight unit of Comparative Example 1, there was observed a phenomenon that portions of which image conditions were different from those of surrounding portions were locally generated on the screen of liquid crystal TV after 3 hours passed from the turning on. Although the local defective image area gradually became smaller with progress of time, they did not completely disappear even after several days passed. Moreover, when an optical member (light diffusing film) incorporated into the liquid crystal TV was taken out and observed, flexure was observed, which was generated because the light diffusing film could not follow the flexed shape.

### BRIEF DESCRIPTION OF THE DRAWINGS

FIG. 1 A sectional view showing an exemplary backlight unit

FIG. 2 An explanatory view for deformation of an optical member due to flexure of light diffusing plate

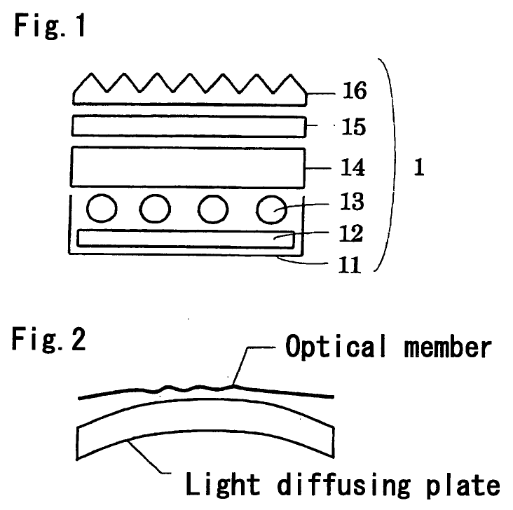

### DESCRIPTION OF NOTATIONS

1 . . . Backlight unit
11 . . . Chassis
12, 15, 16 . . . Optical members
13 . . . Light source
14 . . . Light diffusing plate

1. A backlight unit comprising a light source, a light diffusing plate comprising a synthetic resin and disposed on the light source, and one or more kinds of optical members for backlight unit disposed on the light diffusing plate, wherein both surfaces of the light diffusing plate have an arithmetical mean deviation (Ra) of 0.1 μm or less according to JIS B0601:1994.

2. A backlight unit comprising a light source, a light diffusing plate for diffusing lights from the light source, and one or more kinds of optical members for backlight unit disposed on the light diffusing plate, wherein the light diffusing plate comprises a synthetic resin, and both surfaces of the light diffusing plate have an arithmetical mean deviation (Ra) of 0.1 μm or less according to JIS B0601:1994.

3. The backlight unit according to claim 1, wherein the light diffusing plate has a thickness of 1 mm or larger.

4. The backlight unit according to claim 1, wherein the light diffusing plate contains microparticles in the synthetic resin.

5. The backlight unit according to claim 4, wherein a surface of the light diffusing plate is subjected to a mirror surface processing.

6. The backlight unit according to claim 2, wherein the light diffusing plate has a thickness of 1 mm or larger.

7. The backlight unit according to claim 6, wherein the light diffusing plate contains microparticles in the synthetic resin.

8. The backlight unit according to claim 2, wherein the light diffusing plate contains microparticles in the synthetic resin.

9. The backlight unit according to claim 3, wherein the light diffusing plate contains microparticles in the synthetic resin.

10. The backlight unit according to claim 1, wherein a surface of the light diffusing plate is subjected to a mirror surface processing.

11. The backlight unit according to claim 2, wherein a surface of the light diffusing plate is subjected to a mirror surface processing.

12. The backlight unit according to claim 3, wherein a surface of the light diffusing plate is subjected to a mirror surface processing.

13. The backlight unit according to claim 5, wherein a surface of the light diffusing plate is subjected to a mirror surface processing.

14. The backlight unit according to claim 6, wherein a surface of the light diffusing plate is subjected to a mirror surface processing.

15. The backlight unit according to claim 7, wherein a surface of the light diffusing plate is subjected to a mirror surface processing.

16. The backlight unit according to claim 8, wherein a surface of the light diffusing plate is subjected to a mirror surface processing.

17. The backlight unit according to claim 9, wherein a surface of the light diffusing plate is subjected to a mirror surface processing.
